(19) United States
(12) Patent Application Publication
(10) Pub. No.: US 2026/0268522 A1
(43) Pub. Date: Sep. 10, 2026

(54) ESTIMATION APPARATUS, LEARNING APPARATUS, ESTIMATION METHOD, LEARNING METHOD AND PROGRAM

(71) Applicant: NTT, Inc., Tokyo (JP)

(72) Inventor: Takuhiro KANEKO, Musashino-shi (JP)

(73) Assignee: NTT, Inc., Tokyo (JP)

(21) Appl. No.: 18/869,493

(22) PCT Filed: Jun. 1, 2022
(86) PCT No.: PCT/JP2022/022289

§ 371 Date: Nov. 26, 2024

(51) Int. Cl. G06T 7/80

(52) U.S. Cl. CPC G06T 7/80; G06T 2200/04; G06T 2207/20081; G06T 2207/20084

(57) ABSTRACT

An estimation device includes an estimation unit that estimates a result of imaging by an imaging device by using an estimation model that estimates three-dimensional data of a target to be imaged by the imaging device on the basis of hole position information indicating a position of a hole of an aperture of the imaging device including the aperture, in which information indicating that a size of the hole is not non-zero is used in estimation by the estimation unit.

### TECHNICAL FIELD

The present invention relates to an estimation apparatus, a learning apparatus, an estimation method, a learning method, and a program.

### BACKGROUND ART

An image is a two-dimensional mapping of the three-dimensional world. By the way, the opposite problem, that is, restoration or estimation of three-dimensional information corresponding to a two-dimensional image when the two-dimensional image is given is one of problems that have long attracted attention in the fields of computer vision and computer graphics. This problem is a problem that is expected to be solved in various fields such as robotics, content generation, and image editing, and has been intensively studied for a long time.

As a method for solving this problem, in recent years, a neural network-based method called Neural Radiance Fields (NeRF) (see Non Patent Literature 1) has been proposed. The NeRF includes neural networks c and o that estimate a color c (p, d) and a volume density σ(p) of a point in three dimensions when a coordinate p of the point and a line-of-sight direction d in which the point is observed are given as inputs.

After the color and the volume density are obtained for each point in the three-dimensional space using this neural network, the color of each point is integrated while weighting the volume density on the light beam having the viewpoint as the starting point, whereby the point on the three-dimensional is projected on the two-dimensional plane. By performing this operation on each pixel on the image, a two-dimensional image is generated.

As described above, in the NeRF, learning of a model capable of reproducing the three-dimensional world is achieved in a process of fitting a model to a real two-dimensional image by using a model that explicitly describes a relationship between the three-dimensional world and the two-dimensional image.

### CITATION LIST

### Non Patent Literature

Non Patent Literature 1: Ben Mildenhall, Pratul P. Srinivasan, Matthew Tancik, Jonathan T. Barron, Ravi Ramamoorthi, and Ren Ng. NeRF: Representing scenes as neural radiance fields for view synthesis. In ECCV, 2020.

### SUMMARY OF INVENTION

### Technical Problem

As described above, the mathematical model proposed so far estimates and outputs a result of imaging by a camera. However, the mathematical model proposed so far is a model assuming a pinhole camera. Therefore, in a case of estimating a result of imaging by a camera in which a size of a hole of an aperture is not zero according to the mathematical model proposed so far, the estimation accuracy may be poor.

Specifically, in a case of imaging with a camera in which the size of the hole of the aperture is not zero, blurring may occur in a region not included in the depth of field. However, in the mathematical model proposed so far, since a pinhole camera is assumed, the blurring may not be expressed. As a result, a deviation may occur between the actual image and the generated image. As a result, a deviation may occur between the actual three-dimensional information (depth or the like) and the estimated three-dimensional information. Such a circumstance is not a problem of only the camera but is a common problem also to the imaging device.

In view of the above circumstances, an object of the present invention is to provide a technology of suppressing deterioration in accuracy of estimating a result of imaging by an imaging device.

### Solution to Problem

An aspect of the present invention is an estimation device including an estimation unit that estimates a result of imaging by an imaging device by using an estimation model that estimates three-dimensional data of a target to be imaged by the imaging device on the basis of hole position information indicating a position of a hole of an aperture of the imaging device including the aperture, in which information indicating that a size of the hole is not non-zero is used in estimation by the estimation unit.

An aspect of the present invention is a learning device including a learning unit that learns an estimation model that estimates three-dimensional data of a target to be imaged by an imaging device on the basis of hole position information indicating a position of a hole of an aperture of the imaging device including the aperture, in which, in the learning, one or a plurality of pieces of learning data including input-side data that is data input to a mathematical model of a target to be learned and output-side data that is data used for comparison with an output of the mathematical model of the target to be learned are used, the input-side data includes the hole position information, the output-side data includes a two-dimensional image capturing the target to be imaged, and the mathematical model of the target to be learned in the learning is updated so as to reduce a difference between a set of results of estimation by the mathematical model of the target to be learned and a set of the output-side data.

An aspect of the present invention is an estimation method including an estimation step of estimating a result of imaging by an imaging device by using an estimation model that estimates three-dimensional data of a target to be imaged by the imaging device on the basis of hole position information indicating a position of a hole of an aperture of the imaging device including the aperture, in which information indicating that a size of the hole is not non-zero is used in estimation by the estimation step.

An aspect of the present invention is a learning method including a learning step of learning an estimation model that estimates three-dimensional data of a target to be imaged by an imaging device on the basis of hole position information indicating a position of a hole of an aperture of the imaging device including the aperture, in which, in the learning, one or a plurality of pieces of learning data including input-side data that is data input to a mathematical model of a target to be learned and output-side data that is data used for comparison with an output of the mathematical model of the target to be learned are used, the input-side data includes the hole position information, the output-side data includes a two-dimensional image capturing the target to be imaged, and the mathematical model of the target to be learned in the learning is updated so as to reduce a difference between a set of results of estimation by the mathematical model of the target to be learned and a set of the output-side data.

An aspect of the present invention is a program for causing a computer to function as any one of the estimation device described above and the learning device described above.

### Advantageous Effects of Invention

According to the present invention, it is possible to suppress deterioration of accuracy of estimating a result of imaging by an imaging device.

### BRIEF DESCRIPTION OF DRAWINGS

FIG. 1 is an explanatory diagram for explaining an outline of an estimation system according to an embodiment.

FIG. 2 is an explanatory diagram for explaining an example of a projection rule according to the embodiment.

FIG. 3 is a diagram illustrating an example of a hardware configuration of a learning device according to the embodiment.

FIG. 4 is a diagram illustrating an example of a configuration of a control unit included in the learning device in the embodiment.

FIG. 5 is a flowchart illustrating an example of a flow of processing executed by the learning device according to the embodiment.

FIG. 6 is a diagram illustrating an example of a hardware configuration of an estimation device according to the embodiment.

FIG. 7 is a diagram illustrating an example of a control unit included in the estimation device according to the embodiment.

FIG. 8 is a flowchart illustrating an example of a flow of processing executed by the estimation device according to the embodiment.

FIG. 9 is a diagram illustrating an example of an experimental result according to the embodiment.

FIG. 10 is a first diagram illustrating an example of a result of estimation by an estimation device 2 according to a modification.

FIG. 11 is a second diagram illustrating an example of a result of estimation by the estimation device 2 according to a modification.

### DESCRIPTION OF EMBODIMENTS

### Embodiment

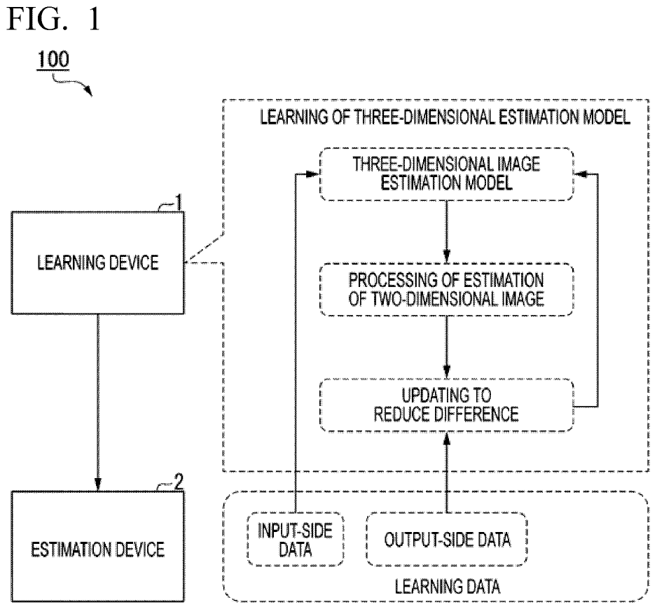

FIG. 1 is an explanatory diagram for explaining an outline of an estimation system 100 according to an embodiment. Prior to description of the estimation system 100, an image appearing in a two-dimensional image will be described. The two-dimensional image is a two-dimensional image obtained by imaging by an imaging device including an aperture. The imaging device is, for example, a camera. In such a case, the two-dimensional image is, for example, a photograph. The imaging device may be, for example, a depth camera. The two-dimensional image may be, for example, a depth image. Even in a case where the imaging device is a depth camera, the two-dimensional image does not need to be a depth image and may be a photograph.

Since the image appearing in the two-dimensional image is obtained by imaging in this manner, it can be said that the image is a result of projecting the three-dimensional image on the two-dimensional plane. Therefore, if the inverse mapping corresponding to the mapping for converting the three-dimensional image into the two-dimensional image is obtained, the three-dimensional image corresponding to the image appearing in the two-dimensional image is obtained as the inverse mapping with respect to the image appearing in the two-dimensional image. Obtaining a three-dimensional image specifically means obtaining a volume density and a color of a three-dimensional image at each position in a three-dimensional space.

The definition of the volume density is a definition of the volume density in a technical field in which three-dimensional information corresponding to a two-dimensional image is obtained when the two-dimensional image is given. Therefore, the volume density is a probability that light beams are not transmitted.

The estimation system 100 will be described. The estimation system 100 includes a learning device 1 and an estimation device 2.

The learning device 1 learns a three-dimensional image estimation model until a predetermined condition regarding the end of learning (hereinafter, referred to as a “learning end condition”) is satisfied. The learning means machine learning. The learning end condition may be any condition as long as it is a condition related to the end of learning, and may be, for example, a condition that the mathematical model has been updated a predetermined number of times. The learning end condition may be, for example, a condition that a change in the mathematical model due to the update is smaller than a predetermined change. The mathematical model at the time when the learning end condition is satisfied is the learned mathematical model.

The three-dimensional image estimation model is a mathematical model that estimates three-dimensional data of a target to be imaged by the imaging device on the basis of at least hole position information. As described above, the imaging device includes an aperture. The three-dimensional image estimation model may be a mathematical model that estimates three-dimensional data of a target to be imaged by the imaging device, further on the basis of hole orientation information.

The hole position information is information indicating the position of the hole of the aperture of the imaging device. The position of the hole of the aperture may be indicated in any manner as long as the position of the hole of the aperture is indicated identifiably from other positions. Therefore, the position of the hole of the aperture may be indicated, for example, by the position of the center of the hole of the aperture.

The hole position information may indicate the position of the hole of the aperture by any method as long as it indicates the relationship between the position of the hole of the aperture and the position of the target to be imaged. Therefore, the hole position information may be, for example, information indicating the position of the hole of the aperture using a coordinate system to which information indicating the position where the contour of the target to be imaged exists is assigned.

The hole orientation information indicates the orientation of the hole of the aperture. The orientation of the holes is perpendicular to the face of the hole of the aperture. Estimating a three-dimensional image specifically means estimating a volume density and a color of a three-dimensional image at each position in a three-dimensional space.

The three-dimensional image estimation model includes processing based on information (hereinafter, referred to as “hole size information”) indicating the size of the hole of the aperture and information (hereinafter, referred to as “focal length information”) indicating the focal length of the imaging device. Therefore, the three-dimensional image estimation model is a mathematical model that estimates three-dimensional data of a target to be imaged on the basis of the size of the hole of the aperture indicated by the hole size information and the focal length included in the focal length information. The size of the hole of the aperture is, for example, the radius of the hole of the aperture.

In the three-dimensional image estimation model, the orientation of the hole of the aperture, the size of hole of the aperture, or the focal length may be a parameter updated by learning, or may be a predetermined value given in advance. Specifically, the orientation of the hole of the aperture, the size of the hole of the aperture, or the focal length may be set for each of the input-side data included in the learning data to be described later, or the orientation of the hole of the aperture, the size of the hole of the aperture, or the focal length may be set for each of the output-side data included in the learning data. The orientation of the hole of the aperture, the size of the hole of the aperture, or the focal length may be included in the three-dimensional image estimation model as one of parameters updated by learning. One value may be set for the orientation of the hole of the aperture, the size of the hole of the aperture, or the focal length, or the orientation of the hole of the aperture, the size of the hole of the aperture, or the focal length may be set so as to express the distribution of the parameters.

The learning data in the learning of the three-dimensional image estimation model includes input-side data and output-side data. The input-side data is data input to the mathematical model of the target to be learned. The output-side data is data used for comparison with the output of the mathematical model of the target to be learned. Hereinafter, the learning data used in the three-dimensional image estimation model is referred to as three-dimensional learning data. A mathematical model of the target to be learned in learning using three-dimensional learning data is a three-dimensional image estimation model.

The output-side data in the three-dimensional learning data includes a two-dimensional image (hereinafter, referred to as a “target two-dimensional image”) that shows a target to be imaged. The input-side data in the three-dimensional learning data is information including at least hole position information. In the hole position information included in the input-side data in the three-dimensional learning data, one value may be set, or a value sampled from a predetermined distribution may be set. The hole position information may be set for each of pieces of output-side data included in the learning data, or the hole position information may be set independently of the output-side data. The value of the hole position information may be estimated from each of pieces of output-side data. The hole position information may be optimized simultaneously with the learning of the three-dimensional image estimation model as one of the parameters updated by the learning.

The input-side data in the three-dimensional learning data may include hole orientation information. However, the hole orientation information is not necessarily included in the input-side data of the three-dimensional learning data. When the hole orientation information is not included in the input-side data of the three-dimensional learning data, the hole orientation information may have been stored in advance in a predetermined storage device such as a storage unit 14 described later. In such a case, when the three-dimensional image estimation model is executed, the hole orientation information may be read from a predetermined storage device and used for estimation by the three-dimensional image estimation model.

In the learning of the three-dimensional image estimation model, three-dimensional image estimation processing, two-dimensional image estimation processing, and update processing are performed. The three-dimensional image estimation processing is processing of estimating three-dimensional data of a target to be imaged by executing a three-dimensional image estimation model. The three-dimensional image estimation processing is executed on the input-side data included in the three-dimensional learning data.

The two-dimensional image estimation processing is processing of obtaining an estimation result image on the basis of the three-dimensional image estimated by the three-dimensional image estimation processing. The estimation result image is a two-dimensional image obtained by the imaging device in which the aperture is located at the position indicated by the hole position information. The estimation result image is a two-dimensional image corresponding to the content of the two-dimensional image estimation processing, and may be, for example, a photograph or a depth image.

The two-dimensional image obtained by the imaging device is a result of imaging by the imaging device. Therefore, it can also be said that the two-dimensional image estimation processing is processing of estimating a result of imaging by the imaging device in which the aperture is located at the position indicated by the hole position information on the basis of the three-dimensional image estimated by the three-dimensional image estimation processing. The estimation result image is a two-dimensional image obtained by two-dimensional image estimation processing. Therefore, the estimation result image is a two-dimensional image obtained on the basis of the estimation result of the three-dimensional image estimation model.

The two-dimensional image estimation processing may be any process as long as it is processing of estimating an estimation result image on the basis of a three-dimensional image estimated by the three-dimensional image estimation processing.

The two-dimensional image estimation processing may be, for example, processing of obtaining a three-dimensional image from a two-dimensional image according to a predetermined rule of obtaining a three-dimensional image (hereinafter, referred to as an “inverse projection rule”) and then obtaining a two-dimensional image according to a predetermined rule (hereinafter, referred to as a “projection rule”) of obtaining a two-dimensional image on the basis of the three-dimensional image. Therefore, the two-dimensional image estimation processing is, for example, processing of obtaining a three-dimensional image from a two-dimensional image (for example, a photograph or a depth image) according to the inverse projection rule, and then obtaining the same or different types of two-dimensional images (for example, a photograph or a depth image) from the three-dimensional image according to the projection rule. An example of the processing of obtaining a three-dimensional image according to the inverse projection rule is processing of obtaining hole position information on the basis of a two-dimensional image, and then obtaining a three-dimensional image from the hole position information by three-dimensional image estimation processing.

The processing of obtaining the two-dimensional image according to the projection rule may be, for example, processing of executing a two-dimensional image estimation model obtained in advance. The two-dimensional image estimation model is a mathematical model that estimates a two-dimensional image according to a projection rule.

Here, an example of the projection rule will be described.

### <Example of Projection Rule>

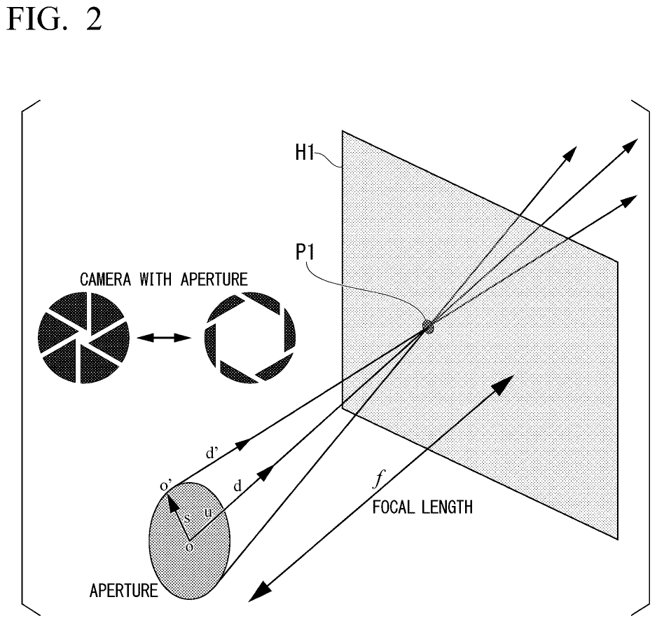

FIG. 2 is an explanatory diagram illustrating an example of a projection rule according to the embodiment. Hereinafter, the term “light beam” and the term “direction of light beam” are used, and the definition of each term is a definition in the technical field in which three-dimensional information corresponding to a two-dimensional image is obtained when the image is given. That is, the light beam means a path through which light propagates. The direction of light beam means the positive direction of the light beam. The positive direction of the light beam is a direction in which the target to be imaged is viewed from the aperture.

In the projection rule (hereinafter, referred to as an “example rule”) described using the explanatory diagram of FIG. 2, the shape of the hole of the aperture is circular. Here, as an example, a case where the shape of the hole is circular will be described, but the hole may have any shape such as a regular polygon. The exemplification rule is a rule using information indicating the size of the hole of the aperture, and is a rule expressing a phenomenon occurring at the time of imaging by the imaging device. In the exemplification rule, the light beam passing through the aperture is a light beam having a position vector o′ expressed by the following Expression (1) as an origin. The origin of the light beam means the start point of the vector indicating the direction of the light beam.

$$\begin{matrix}[ Math . 1 ] & \\ {o}^{′} = o + u & ( 1 )\end{matrix}$$

Here, the vector o is a position vector indicating the center of the hole of the aperture. The vector u is a vector orthogonal to the vector o and has a magnitude of 0 to s. s is the radius of the hole of the aperture. Therefore, the vector o′ is a position vector indicating a position in a circle of the center o and the radius s.

The orientation d′ of the light beam at the origin o′ is expressed by the following Expression (2) using the center o of the hole of the aperture.

$$\begin{matrix}[ Math . 2 ] & \\ {d}^{′} = ( o + fd - {o}^{′} ) / f & ( 2 )\end{matrix}$$

The vector d is a vector indicating the orientation of the hole of the aperture. The value f represents the distance to the focal plane. Therefore, the value f is a non-negative real number. The definition of the focal plane is a plane in which the light beam convergence point exists. The light beam convergence point is a point at which a light beam group passing through the aperture converges. The definition of the light beam group is a plurality of light beams. In the example of FIG. 2, the light beam convergence point is a point P1. In the example of FIG. 2, the focal plane is a plane H1.

When the vector o, the vector u, and the distance f are given from the Expressions (1) and (2), the origin o′ and the orientation d′ can be calculated. If the origin o′ and the orientation d′ are calculated, a vector representing the light beam r′ starting from the point o′ is also obtained. The light beam r′ starting from the point o′ is expressed by the following Expression (3).

$$\begin{matrix}[ Math . 3 ] & \\ {r}^{′} = {o}^{′} + {td}^{′} & ( 3 )\end{matrix}$$

t is a real number of tₙ or more and t_{f} or less. tₙ and t_{f} are real numbers having a relationship of tₙ<t_{f}. tₙ and t_{f} indicate, for example, a range including the light beam and the three-dimensional image of the target to be imaged, including a range where the light beam and the three-dimensional image of the target to be imaged intersect.

When Expression (3) is obtained, the color C(r′) and the depth Z(r′) of the pixel on the image plane corresponding to the light beam r′ are obtained by executing the processing expressed by the following Expressions (4) to (6) called volume rendering. The image plane corresponding to the light beam r′ is the plane H1 in FIG. 2. That is, the image plane corresponding to the light beam r′ is the focal plane.

In the following Expressions (4) to (6), r is used instead of r′ and d is used instead of d′ for simplification of expression.

$$\begin{matrix}[ Math . 4 ] & \\ C ( r ) = {\int }_{{t}_{n}}^{{t}_{f}} T ( t ) σ ( r ( t ) ) c ( r ( t ) , d ) dt & ( 4 )\end{matrix}$$

$$\begin{matrix}[ Math . 5 ] & \\ Z ( r ) = {\int }_{{t}_{n}}^{{t}_{f}} T ( t ) σ ( r ( t ) ) tdt , & ( 5 )\end{matrix}$$

$$\begin{matrix}[ Math . 6 ] & \\ T ( t ) = exp ( - {\int }_{{t}_{n}}^{t} σ ( r ( s ) ) ds ) & ( 6 )\end{matrix}$$

c (p, d) is a value indicating a color at the position p and the orientation d. σ(p) represents the volume density at the position p.

Expressions (4) to (6) require calculation of integration, but may be difficult to execute. This is because while the integral is defined for a continuous quantity, it is difficult for a computer to handle the continuous quantity. Therefore, instead of the integrals of Expressions (4) to (6), the computer may obtain approximate values of the integrals of Expressions (4) to (6) using discrete points. That is, for example, integration may be approximately calculated for discrete points. For example, the integration may be approximately calculated for points obtained by dividing the integration range at predetermined intervals. For example, weighting may be performed on the distribution of points on the basis of a result calculated once, and integration may be approximately calculated for points obtained as a result of resampling.

For the integration, for example, the color and depth of the pixel for the corresponding light beam r′ may be calculated for each discrete representative origin o′, and the obtained average of the plurality of colors and depths may be obtained instead of the result of the integration. The representative origin is a point selected according to a predetermined rule among points located in the hole of the aperture.

Therefore, the representative origin may be, for example, a point randomly selected from among points located in the hole of the aperture, or a point selected according to a rule of every predetermined interval among points located in the hole of the aperture. Among points located in the hole of the aperture, points having a high possibility that an object is present on a light beam starting from the point may be intensively selected.

The example rule indicates execution of whole integration processing. The whole integration processing is processing of integrating at least the color C(r′) of the pixel with respect to all the light beams r′ satisfying the condition that the magnitude of the vector u is 0 or more and less than s. In the whole integration processing, the depth Z(r′) may be further integrated for all the light beams r′ satisfying the condition that the magnitude of the vector u is 0 or more and less than s.

However, regarding the depth in the example rule, it is not always necessary to perform the integration for all the light beams r′ satisfying the condition that the magnitude of the vector u is 0 or more and less than s. The depth may be, for example, the depth Z(r) obtained for a center light beam r. The center light beam r is a light beam starting from the center of the hole of the aperture.

The example rule is a rule that information indicating the color or depth obtained for each pixel in this manner is output as a two-dimensional image.

In a case of a rule indicating that a value of each pixel is obtained by using not only a value obtained based on a single light beam but also a value obtained based on a light beam group as in the example rule, a two-dimensional image obtained according to the rule expresses an influence of a depth of field effect (that is, blur effect). In the two-dimensional image obtained in this manner, all the light beams entering the aperture are in focus at a point where they intersect at one point, and blurring occurs at a point where the light beam group spreads. Hereinafter, a rule indicating that the value of each pixel is obtained using not only the value obtained based on the single light beam but also the value obtained based on the light beam group is referred to as a blur effect estimation rule.

The processing represented by Expressions (1) to (6) and the whole integration processing may also be included in the three-dimensional image estimation model. In such a case, the processing represented by Expressions (1) to (6) and the whole integration processing are examples of processing based on the hole size information and the focal length information. The description returns to FIG. 1.

The update processing is processing of updating the three-dimensional image estimation model so as to reduce a difference between a set of two-dimensional images (hereinafter, referred to as an “estimated two-dimensional image”) obtained by the two-dimensional image estimation processing and a set of target two-dimensional images. The updating of the mathematical model means that values of parameters of the mathematical model are updated. Here, the set represents a set of data having one or more elements.

Specifically, in the update processing, the three-dimensional image estimation model may be updated so as to reduce the difference while associating the estimated two-dimensional image and the target two-dimensional image on a one-to-one basis, or the three-dimensional image estimation model may be updated so as to reduce the difference between the estimated two-dimensional image group and the target two-dimensional image group as a whole. The estimated two-dimensional image group is a set of estimated two-dimensional images having the number of elements of 1 or more, and the target two-dimensional image group is a set of target two-dimensional images having the number of elements of 1 or more.

Specifically, in a case where the difference is reduced while the estimated two-dimensional image and the target two-dimensional image are associated with each other on a one-to-one basis, the learning of the three-dimensional image estimation model may be performed using a loss function based on an arbitrary distance standard. The loss function may be, for example, a function based on the L2 distance, a function based on the L1 distance, or a function based on the Wasserstein distance. The loss function may be a hinge function that allows a difference of a certain value or less. These loss functions may be combined.

In a case where the difference between the estimated two-dimensional image group and the target two-dimensional image group is reduced in the entire group, the learning of the three-dimensional image estimation model may be performed using a loss function based on any generation model. The generation model may be, for example, a Generative Adversarial Network (GAN), a Variational Autoencoder (VAE), a Flow Model, a Diffusion Probabilistic Model, or an Autoregressive Model. In addition, these generation models may be combined.

The learning of the three-dimensional image estimation model using the GAN is an example of learning (hereinafter, referred to as “conflict learning”) in which the estimation unit 211 to be described later is used as a generator, a discriminator that discriminates a set of results of estimation by the generator and a set of output-side data is included, and the generator and the discriminator learn the target to be learned according to optimization conditions that conflict with each other. That is, the learning of the three-dimensional image estimation model may be performed by, for example, conflict learning, and for example, GAN may be used as the conflict learning.

The estimation device 2 estimates a two-dimensional image of the target to be imaged using the three-dimensional image estimation model obtained by the learning device 1. For simplicity of the following description, the estimation system 100 will be described using a case where the three-dimensional learning data includes output-side data as an example.

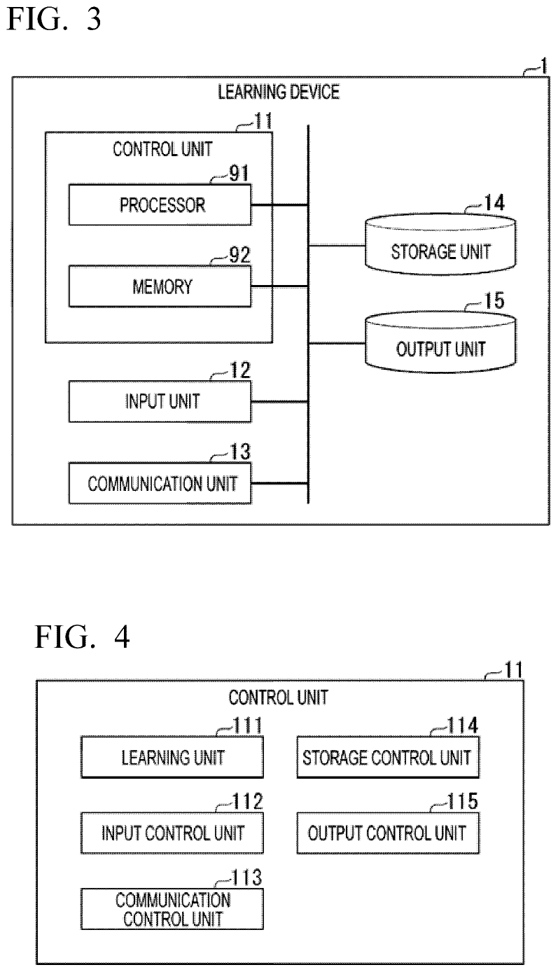

FIG. 3 is a diagram illustrating an example of a hardware configuration of the learning device 1 according to the embodiment. The learning device 1 includes a control unit 11 including a processor 91 such as a central processing unit (CPU) or a graphics processing unit (GPU) connected via a bus and a memory 92, and executes a program. The learning device 1 functions as a device including the control unit 11, an input unit 12, a communication unit 13, a storage unit 14, and an output unit 15 by executing a program.

More specifically, the processor 91 reads a program stored in the storage unit 14, and stores the read program in the memory 92. In a case where the processor 91 executes the program stored in the memory 92, the learning device 1 functions as a device including the control unit 11, the input unit 12, the communication unit 13, the storage unit 14, and the output unit 15.

The control unit 11 controls operations of various functional units included in the learning device 1. The control unit 11 executes, for example, three-dimensional image estimation processing, two-dimensional image estimation processing, and update processing.

The input unit 12 includes an input device such as a mouse, a keyboard, or a touchscreen. The input unit 12 may be configured as an interface that connects these input devices to the learning device 1. The input unit 12 receives inputs of various types of information to the learning device 1. For example, an instruction to start learning by the user is input to the input unit 12. For example, three-dimensional learning data is input to the input unit 12.

The communication unit 13 includes a communication interface for connecting the learning device 1 to an external device. The communication unit 13 communicates with an external device in a wired or wireless manner. The external device is, for example, a device that is a transmission source of the three-dimensional learning data. The communication unit 13 acquires the three-dimensional learning data by communicating with a transmission source device of the three-dimensional learning data. The transmission sources of the input-side data and the output-side data of the three-dimensional learning data may be different devices.

The storage unit 14 is configured by using a computer-readable storage medium device such as a magnetic hard disk device or a semiconductor storage device. The storage unit 14 stores various types of information regarding the learning device 1. The storage unit 14 stores, for example, information input via the input unit 12 or the communication unit 13. The storage unit 14 stores, for example, a three-dimensional image estimation model. The storage unit 14 stores, for example, a learned three-dimensional image estimation model. The storage unit 14 may or may not store the hole orientation information in advance, for example.

The output unit 15 outputs various types of information. The output unit 15 includes, for example, a display device such as a cathode ray tube (CRT) display, a liquid crystal display, or an organic electro-luminescence (EL) display. The output unit 15 may be configured as an interface that connects these display devices to the learning device 1. The output unit 15 outputs, for example, information input to the input unit 12 or the communication unit 13.

FIG. 4 is a diagram illustrating an example of a configuration of the control unit 11 included in the learning device 1 in the embodiment. The control unit 11 includes a learning unit 111, an input control unit 112, a communication control unit 113, a storage control unit 114, and an output control unit 115.

The learning unit 111 learns a three-dimensional image estimation model. Therefore, the learning unit 111 executes three-dimensional image estimation processing, two-dimensional image estimation processing, and update processing. The input control unit 112 controls the operation of the input unit 12. The communication control unit 113 controls an operation of the communication unit 13. The storage control unit 114 controls the operation of the storage unit 14. The output control unit 115 controls the operation of the output unit 15.

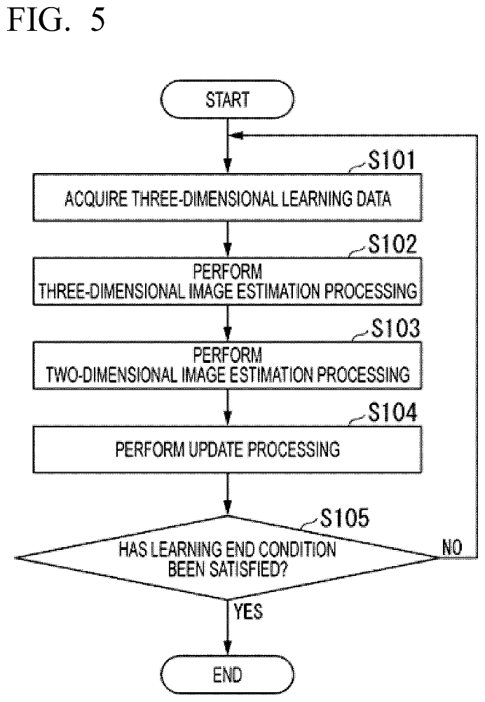

FIG. 5 is a flowchart illustrating an example of a flow of processing executed by the learning device 1 according to the embodiment. One or a plurality of pieces of three-dimensional learning data is input to the input unit 12 or the communication unit 13 (step S101). Next, the learning unit 111 executes three-dimensional image estimation processing on each piece of input-side data included in each piece of three-dimensional learning data (step S102).

Next, the learning unit 111 executes two-dimensional image estimation processing (step S103). By execution of the two-dimensional image estimation processing, a two-dimensional image obtained by the imaging device in which the aperture is located at the position indicated by the hole position information is estimated as an estimation result image on the basis of the estimation result by the three-dimensional image estimation processing. The hole position information is information included in the input-side data included in the three-dimensional learning data.

Next, the learning unit 111 executes update processing (step S104). In the update processing, the three-dimensional image estimation model is updated on the basis of the difference between the set of estimation result images obtained in step S103 and the set of imaging target two-dimensional images so as to reduce the difference. The imaging target two-dimensional image is included in the three-dimensional learning data as output-side data.

Next, the learning unit 111 determines whether or not the learning end condition is satisfied (step S105). In a case where the learning end condition is satisfied (step S105: YES), the processing ends. On the other hand, when the learning end condition is not satisfied (step S105: NO), the processing returns to step S101.

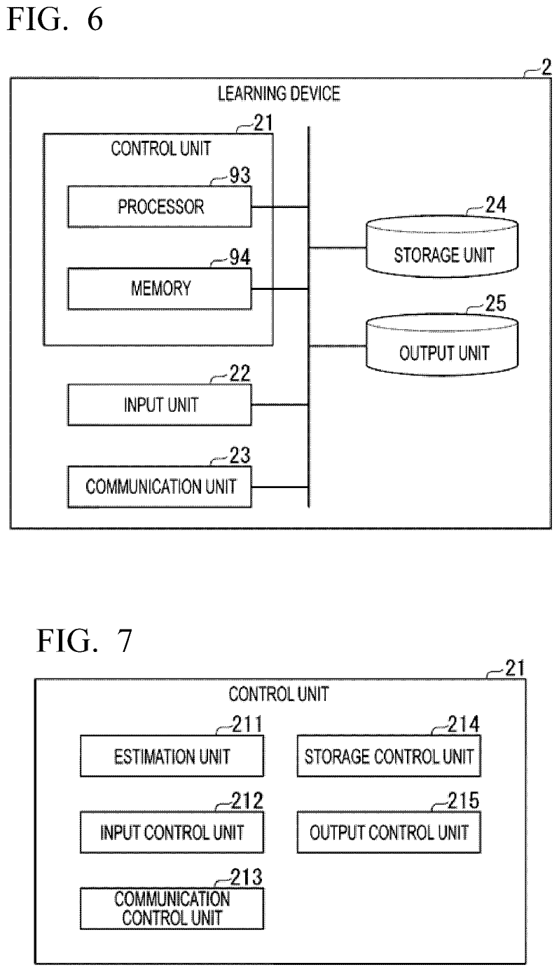

FIG. 6 is a diagram illustrating an example of a hardware configuration of the estimation device 2 according to the embodiment. The estimation device 2 includes a control unit 21 including a processor 93 such as a CPU and a GPU and a memory 94, which are connected to each other via a bus, and executes a program. In a case where the program is executed, the estimation device 2 functions as a device including the control unit 21, an input unit 22, a communication unit 23, a storage unit 24, and an output unit 25.

The control unit 21 controls operations of various functional units included in the estimation device 2. The control unit 21 executes, for example, a learned three-dimensional image estimation model.

The input unit 22 includes an input device such as a mouse, a keyboard, or a touchscreen. The input unit 22 may be configured as an interface that connects these input devices to the estimation device 2. The input unit 22 receives inputs of various types of information to the estimation device 2. For example, an instruction to start estimation by the user is input to the input unit 22.

For example, information (hereinafter referred to as “input information”) to be input to the learned three-dimensional image estimation model is input to the input unit 22. The input information is information of the same type as that of the input-side data of the three-dimensional learning data. Therefore, the input information includes at least hole position information. When the input-side data of the three-dimensional learning data includes the hole orientation information, the input information further includes the hole orientation information.

The communication unit 23 includes a communication interface for connecting the estimation device 2 to an external device. The communication unit 23 communicates with an external device in a wired or wireless manner. The external device is, for example, a device as a transmission source of the hole position information. The communication unit 23 acquires the input information by communication with the transmission source device of the input information.

The storage unit 24 is configured by using a computer-readable storage medium device such as a magnetic hard disk device or a semiconductor storage device. The storage unit 24 stores various types of information related to the estimation device 2. The storage unit 24 stores, for example, information input via the input unit 22 or the communication unit 23. The storage unit 24 stores, for example, a learned three-dimensional image estimation model. The storage unit 24 may or may not store the hole orientation information in advance, for example.

The output unit 25 outputs various types of information. The output unit 25 includes, for example, a display device such as a CRT display, a liquid crystal display, or an organic EL display. The output unit 25 may be configured as an interface that connects these display devices to the estimation device 2. The output unit 25 outputs, for example, information input to the input unit 22 or the communication unit 23.

FIG. 7 is a diagram illustrating an example of the control unit 21 included in the estimation device 2 according to the embodiment. The control unit 21 includes an estimation unit 211, an input control unit 212, a communication control unit 213, a storage control unit 214, and an output control unit 215.

The estimation unit 211 executes a learned three-dimensional image estimation model. More specifically, the estimation unit 211 estimates a three-dimensional image on the basis of the input information by executing the learned three-dimensional image estimation model. After executing the learned three-dimensional image estimation model, the estimation unit 211 further executes two-dimensional image estimation processing. By executing the two-dimensional image estimation processing, the estimation unit 211 obtains a result of imaging by the imaging device including the aperture that satisfies the condition indicated by the input information, on the basis of the three-dimensional image estimated by the learned three-dimensional image estimation model.

The input control unit 212 controls the operation of the input unit 22. The communication control unit 213 controls an operation of the communication unit 23. The storage control unit 214 controls the operation of the storage unit 24. The output control unit 215 controls the operation of the output unit 25.

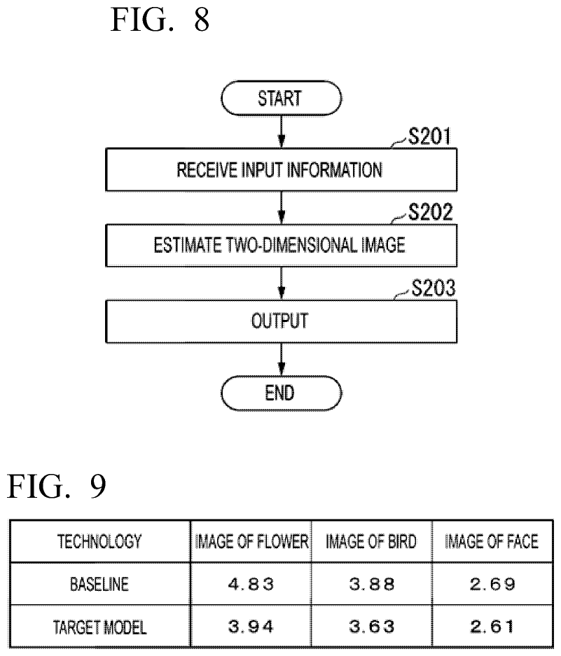

FIG. 8 is a flowchart illustrating an example of a flow of processing executed by the estimation device 2 according to the embodiment. The input information is input to the input unit 22 or the communication unit 23 (step S201). That is, the input unit 22 or the communication unit 23 receives at least the hole position information.

Next, using the learned three-dimensional image estimation model, the estimation unit 211 estimates the result of imaging by the imaging device in which the aperture is located at the position indicated by the input information (step S202). More specifically, the estimation unit 211 first executes the learned three-dimensional image estimation model and then executes two-dimensional image estimation processing, thereby estimating a result of imaging by the imaging device in which the aperture is located at the position indicated by the input information. Next, the output control unit 215 controls the operation of the output unit 25 to cause the output unit 25 to output the estimation result obtained in step S202 (step S203).

The estimation system 100 according to the embodiment configured as described above includes the learning device 1. The learning device 1 updates a three-dimensional image estimation model including processing based on information indicating the size of the hole of the aperture and information indicating the focal length of the imaging device, by learning. Therefore, even when a blurred image is included in the data set, the estimation system 100 can suppress deterioration in accuracy of estimating an imaging result by the imaging device.

### (Modification)

The three-dimensional image estimation model may estimate a three-dimensional image according to a target to be imaged. That is, the three-dimensional image estimation model may include a latent variable z, which is a quantity indicating the target to be imaged, as one of the parameters updated by learning. In such a case, the three-dimensional image estimation model includes information (hereinafter, referred to as “imaging target identification information”) for identifying a target to be imaged. The imaging target identification information may be included in the input-side data.

The latent variable z may follow any predetermined distribution such as a Gaussian distribution, a uniform distribution, a binomial distribution, or a multinomial distribution. The value of the latent variable z may be estimated using a neural network or the like when additional information such as an image is given.

Even when the three-dimensional image estimation model includes, as one of the parameters, the latent variable z that is the amount for identifying the target to be imaged, the two-dimensional image estimation processing is similar to that in a case where the three-dimensional image estimation model does not include, as one of the parameters, the latent variable z that is the amount for identifying the target to be imaged.

The latent variable z may also be used at the time of estimation by the estimation device 2. That is, the input information may include the latent variable z.

The machine learning method used for learning the three-dimensional image estimation model may be any method as long as it is a machine learning method capable of updating the three-dimensional image estimation model using the three-dimensional learning data.

The machine learning method used for learning the three-dimensional image estimation model may be, for example, a method of updating the three-dimensional image estimation model so as to reduce a difference between a set of estimated two-dimensional images and a set of target two-dimensional images. When the machine learning method used for learning the three-dimensional image estimation model is a method of making the difference small while the estimated two-dimensional image and the target two-dimensional image are associated one by one, the method may be a method of learning the three-dimensional image estimation model using a loss function based on an arbitrary distance standard. The loss function may be, for example, a function based on the L2 distance, a function based on the L1 distance, or a function based on the Wasserstein distance. The loss function may be a hinge function that allows a difference of a certain value or less. These loss functions may be combined.

In a case where the difference between the estimated two-dimensional image group and the target two-dimensional image group is reduced in the entire group, the learning of the three-dimensional image estimation model may be performed using a loss function based on any generation model. The generation model may be, for example, a GAN, a VAE, a Flow Model, a Diffusion Probabilistic Model, or an Autoregressive Model. In addition, these generation models may be combined.

When learning is performed by the method based on GAN, the loss function is expressed by, for example, the following Expression (7).

$$\begin{matrix}[ Math . 7 ] & \\ {ℒ}_{GAN} = {𝔼}_{{I}^{r} ∼ {p}^{r} ( I )} [ log D ( {I}^{r} ) ] + {E}_{z ∼ {p}^{g} ( z )} [ log ( 1 - D ( G ( z ) ) ) ] & ( 7 )\end{matrix}$$

Among the symbols in Expression (7), symbols I^{r} to p^{r}(I) represent processing of sampling the target two-dimensional image I^{r} on the basis of the target two-dimensional image distribution p^{r}(I). Among the symbols in Expression (7), symbols z to p^{g}(z) represent processing of sampling the latent variable z on the basis of the latent variable distribution p^{g} (z).

As described above, the latent variable distribution p^{g}(z) follows a predetermined arbitrary distribution such as a Gaussian distribution, a uniform distribution, a binomial distribution, and a multinomial distribution. In such a case, a parameter representing a shape of a distribution such as an average or a variance may be included in the three-dimensional image estimation model as a learnable parameter and optimized during learning. The value of the z may be estimated using a neural network or the like when additional information such as an image is given.

In the symbols of Expression (7), D represents a discriminator in the GAN. That is, the symbol D indicates a discriminator that discriminates the real image and the generated image. The discriminator D is optimized so as to increase the accuracy of identification between the real image and the generated image by maximizing the value of Expression (7).

In the symbols of Expression (7), G represents a generator in the GAN. The generator G is optimized to reduce the accuracy of identification by the discriminator D by minimizing the value of Expression (7). As described above, the generator G can generate an image that is not determined to be a real image by the discriminator D by being optimized under a competing condition in which one maximizes and the other minimizes. The estimation device 2 is an example of the generator G.

In the learning by the GAN-based method, the loss function is not necessarily a loss function based on the cross entropy such as Expression (7). The loss function may be, for example, a loss function based on a predetermined arbitrary distance standard. The loss function may be, for example, a function based on the L2 distance, a function based on the L1 distance, or a function based on the Wasserstein distance. The loss function may be a hinge function that allows a difference of a certain value or less. These loss functions may be combined.

When the loss function is Expression (7), in optimization of G, for example, log (1−D(G(z))) is minimized. However, instead of minimization of log(1−D(G(z))), minimization of −log D(G(z)) may be performed.

In Expression (7), learning may be performed while the size s of the hole of the aperture, the focal length f of the imaging device, and the latent variable z are independently sampled. For example, when the size s of the hole of the aperture and the latent variable z are independently sampled, Expression (7) is replaced with Expression (8) below.

$$\begin{matrix}[ Math . 8 ] & \\ {ℒ}_{AR ∼ NeRF} = {𝔼}_{{I}^{r} ∼ {p}^{r} ( I )} [ log D ( {I}^{r} ) ] + {E}_{z ∼ {p}^{g} ( z ) , s ∼ {p}^{g} ( s )} [ log ( 1 - D ( G ( z , s ) ) ) ] & ( 8 )\end{matrix}$$

In Expression (8), since it is clearly indicated that G depends on s, the generator G is expressed as G (z, s).

p^{g}(s) follows a predetermined any distribution such as a semi-normal distribution, a uniform distribution having a positive value, a binomial distribution, or a multinomial distribution. In such a case, a parameter representing a shape of a distribution such as an average or a variance may be included in the three-dimensional image estimation model as a learnable parameter and optimized during learning. The value of the s may be estimated using a neural network or the like when additional information such as an image is given.

### <Experiment Result>

In the experiment, the depth estimator (hereinafter, referred to as an “target model depth estimator”) learned using the photograph and the depth image obtained on the basis of the learned three-dimensional image estimation model is used for evaluating the performance of the learning device 1 and the estimation device 2. Specifically, first, a three-dimensional image was obtained by a learned three-dimensional image estimation model, and then a pair of a photograph and a depth image was estimated by two-dimensional image estimation processing. Next, learning of the target model depth estimator that converts the photograph into the depth image is performed using the photograph and the depth image forming the pair as learning data.

Then, a depth image (hereinafter, referred to as a “target model depth image”) estimated from the evaluation photograph using the target model depth estimator was used for evaluation. As a technology to be compared (that is, a baseline technique), a mathematical model on the premise of a pinhole camera was used. Specifically, learning of the depth estimator (hereinafter, referred to as a “baseline depth estimator”) was performed using the photograph and the depth image obtained on the basis of this mathematical model, and the depth image (hereinafter, referred to as a “baseline depth image”) estimated from the evaluation photograph using the baseline depth estimator was used for evaluation.

In the experiment, the degree of matching between the estimated depth image (that is, the target model depth image or the baseline depth image) and the predetermined standard was used as an index for evaluation of the learning device 1. The degree of matching was measured using Scale-Invariant Depth Error (SIDE). The smaller the value of SIDE, the higher the degree of matching, and the better the performance.

Specifically, a depth image (hereinafter, referred to as a “reference depth image”) estimated from the evaluation photograph using a depth estimator that has been subjected to learning using a large number of various stereo images as learning data and is known to have high performance was used as a predetermined reference. Therefore, in the experiment, the depth image (that is, the target model depth image or the baseline depth image) estimated by the depth estimator (that is, the target model depth estimator or the baseline depth estimator) that has performed learning on the basis of the mathematical model of the evaluation target is compared with the reference depth image, and the higher the degree of matching is, the higher the performance of the mathematical model of the evaluation target is.

FIG. 9 is a diagram illustrating an example of results of experiments according to the modification. FIG. 9 illustrates a result of an experiment for each of the “baseline” and the learned three-dimensional estimation model (hereinafter, referred to as a “target model”) obtained by the learning device 1 through learning by the above-described GAN-based method. The “baseline” technology is a technology to be compared with the target model. FIG. 9 illustrates that three types of data sets of “flower image”, “bird image”, and “face image” are used as data sets at the time of learning and estimation. The “flower image” means an image of a flower. The “bird image” means an image of a bird. The “face image” means an image of a face.

FIG. 9 illustrates that the value of SIDE of the target model is smaller than that of the technology to be compared for any type of data set. That is, FIG. 9 illustrates that the target model has higher estimation accuracy than the technology to be compared for any type of data set.

The data set at the time of learning or estimation may include a blurred image.

The case where the size s of the hole of the aperture and the focal length f are independently sampled and the case where the focal length f and the latent variable z are independently sampled are similar to the case where the size s of the hole and the latent variable z are independently sampled. The case where s, f, and z are independently sampled is similar to the case where the size s of the hole and the latent variable z are independently sampled.

As described above, learning is performed while each variable is independently sampled, so that separate expressions are obtained for each variable. As a result, the generator G can control each variable independently.

The significance of a case where learning is performed while s and z are independently sampled will be described. When only s is changed while z is fixed, the generator G can change only the depth of field effect while fixing the content of the image. Specifically, the content of the image means content other than the depth of field effect. When only z is changed while s is fixed, the generator G can change only the content of the image while fixing the depth of field effect.

The three-dimensional image estimation model includes, for example, a neural network. The three-dimensional image estimation model is, for example, a neural network that estimates color and volume density. Such a neural network may be, for example, a neural network that estimates color and volume density by different neural networks.

The neural network that estimates the color and the volume density may be a neural network in which the neural network that estimates the color and the neural network that estimates the volume density share at least a part. For example, the neural network that estimates the color and the volume density may be a neural network that estimates the volume density in the first half of the network and estimates the color in the second half.

In the learning of the three-dimensional image estimation model including the latent variable z, sampling may be performed independently of the latent variable z of the neural network that estimates the color and the latent variable z of the neural network that estimates the volume density. Some of these latent variables z may be sampled independently, and other latent variables z may be sampled in a shared manner. The three-dimensional estimation model including the latent variable z means a three-dimensional estimation model including the latent variable z as one of parameters updated by learning.

The color and volume density of each position in a predetermined three-dimensional space including a three-dimensional image may be estimated by the same neural network regardless of the position, or may be estimated by a neural network corresponding to the position in the space. For example, the foreground and the background may be estimated by different neural networks.

When the neural network of the background is executed, Inverted Sphere Parameterization may be used as the coordinate system. This is because, by using Inverted Sphere Parameterization in the background instead of the foreground, it is possible to densely sample points in the vicinity portion and sparsely sample points in the distant portion, and it is possible to efficiently express a wide range. The definition of the foreground of the three-dimensional space is an image close to the viewpoint. Therefore, for example, when the two-dimensional image is a person image, the foreground of the three-dimensional space is an image where a person is present, and the definition of the background of the three-dimensional space is an image away from the viewpoint. Therefore, for example, when the two-dimensional image is a person image, the background of the three-dimensional space is the background behind the person.

### <Details of Effect of Using Inverted Sphere Parameterization>

When a coordinate system of (x′, y′, z′, 1/w) (x′²+y′²+z′²=1, 0<=1/w<=1) is used, a linearly equally spaced coordinate system of (x, y, z) is used. On the other hand, in the case of Inverted Sphere Parameterization, the position of the point is expressed by the direction (x′, y′, z′) viewed from the center of the circle and the distance 1/w. Here, when w is linearly equally spaced, 1/w is dense near the center of the circle and sparse away from the center of the circle. Therefore, when Inverted Sphere Parameterization is used, there is an effect of densely sampling points in the vicinity portion and sparsely sampling points in the far portion.

Since the main target appears in the foreground portion, the sampling is performed densely, and since there is no main target in the background portion, the sampling is made sparse, so that the calculation amount can be reduced. In the background view, in particular, the farther away the object is, the smaller the object becomes, so that degradation of image quality caused by making the object sparse is small.

When the three-dimensional image estimation model includes the latent variable z as one of the parameters updated by learning, the neural network that estimates the color is expressed as, for example, c(p, d, z). That is, the neural network that estimates the color is expressed as, for example, a function that depends on p, d, and z.

In this case, the neural network that estimates the volume density is expressed as σ(p, z). That is, the neural network that estimates the volume density is expressed as, for example, a function that depends on p and z. p represents the position of the hole of the aperture. d represents the orientation of the hole of the aperture.

The latent variable z is not necessarily the same between the neural network that estimates color and the neural network that estimates volume density, and may be different from each other. For example, the neural network that estimates color may be c(p, d, z_{c}), and the neural network that estimates volume density may be σ(p, z_{σ}). z_{c} and z_{σ} do not need to be entirely different, and may partially share each other.

The neural network that estimates the color may be, for example, c (p, z). That is, the neural network that estimates color may be represented as a function that depends on p and z, for example.

In the learning of the three-dimensional image estimation model, learning may be performed while independently sampling the position p of the hole of the aperture in addition to the size s of the hole of the aperture, the focal length f of the imaging device, and the latent variable z. In this case, it is possible to learn an expression in which the size s of the hole of the aperture, the focal length f of the imaging device, the latent variable z, and the position p of the hole of the aperture are separated from each other.

In such a case, in the three-dimensional image estimation model, a change between the depth of field effect and the position p is indicated in a unified framework by using volume rendering. Therefore, since the depth of field effect and the position p are simultaneously learned, the estimation accuracy of the three-dimensional image estimation model is further enhanced.

Furthermore, by using the three-dimensional image estimation model learned in this manner, the user can obtain a two-dimensional image while independently controlling each variable of s, f, z, and p.

In the above description, the case of learning while independently sampling all of s, f, z, and p has been described. However, learning may be performed while independently sampling only some of s, f, z, and p. In this case, it is possible to learn separate representations for independently sampled ones.

The estimation device 2 does not necessarily need to estimate the two-dimensional image using the three-dimensional image estimation model. The estimation device 2 may obtain a two-dimensional image by any method as long as the two-dimensional image is obtained using the estimated three-dimensional image of the mathematical model satisfying the predetermined model condition on the basis of the hole position information, the hole size information, and the focal length information according to the blurring effect estimation rule. The estimation device 2 may perform estimation on the basis of the hole orientation information in addition to the hole position information, the hole size information, and the focal length information.

In the blurring effect estimation rule, as described above, the influence of the depth of field effect (that is, blur effect) is expressed in the two-dimensional image obtained according to the rule. Therefore, according to the blurring effect estimation rule, the estimation device 2 that obtains the two-dimensional image using the three-dimensional image satisfying the model condition on the basis of the hole position information, the hole size information, and the focal length information can obtain the two-dimensional image expressing the influence of the depth of field effect without using the three-dimensional image estimation model. Therefore, such an estimation device 2 can suppress deterioration in accuracy of estimating a result of imaging by the imaging device, as compared with a technology that does not follow the blurring effect estimation rule.

The model condition includes a condition that a color and a volume density of three-dimensional data of a target to be imaged by the imaging device are estimated on the basis of the hole position information. Such a three-dimensional image estimation model is a mathematical model that estimates the color c (p) and the volume density σ (p) on the basis of the position p.

The model condition may further include a condition that the color, the volume density color, and the volume density of the three-dimensional image of the target to be imaged by the imaging device are estimated on the basis of not only the hole position information but also the hole orientation information. Such a three-dimensional image estimation model is a mathematical model that estimates the color c (p, d) and the volume density σ (p, d) on the basis of the position p and the orientation d.

As described above, c (p, d) indicates a color at the position p and the orientation d, and o (p) indicates a volume density at the position p. The mathematical model satisfying the model condition is, for example, the above-described three-dimensional image estimation model. The mathematical model that satisfies the model condition may be, for example, the mathematical model described in Non Patent Literature 1 described above, and may be a mathematical model obtained by learning assuming a pinhole camera. The mathematical model satisfying the model condition may be a mathematical model obtained by learning assuming the above-described camera with an aperture.

The model condition may further include a condition that the color, the volume density color, and the volume density of the three-dimensional image to be captured by the imaging device are estimated on the basis of not only the hole position information but also the imaging target identification information. Such a three-dimensional image estimation model is a mathematical model that estimates the color c (p, z) and the volume density σ(p, z) on the basis of the position p and the latent variable z.

The model condition may further include a condition that the color, the volume density color, and the volume density of the three-dimensional image to be captured by the imaging device are estimated on the basis of not only the hole position information but also the hole orientation information and the imaging target identification information. Such a three-dimensional image estimation model is a mathematical model that estimates the color c (p, d, z) and the volume density σ (p, z) on the basis of the position p, the orientation d, and the latent variable z.

### <Regarding Size of Hole of Aperture in Two-Dimensional Image Estimation Processing>

Meanwhile, the two-dimensional image estimation processing is executed during learning by the learning device 1 and during estimation by the estimation device 2. The two-dimensional image estimation processing is processing of estimating a two-dimensional image from a three-dimensional image according to the projection rule as described above. Although the example rule has been described as an example of the projection rule, the size of the hole of the aperture is used in the estimation of the two-dimensional image in the example rule. The size of the hole of the aperture in the exemplification rule does not need to be non-zero and may be zero. The imaging device in which the size of the hole of the aperture is zero is a pinhole camera.

Therefore, for example, the size of the hole of the aperture may be zero in the projection rule in the two-dimensional image estimation processing executed by the learning device 1, and the size of the hole of the aperture may be non-zero in the projection rule in the two-dimensional image estimation process executed by the estimation device 2. Furthermore, for example, the size of the hole of the aperture may be non-zero in the projection rule in the two-dimensional image estimation processing executed by the learning device 1, and the size of the hole of the aperture may be zero in the projection rule in the two-dimensional image estimation process executed by the estimation device 2.

Furthermore, for example, the size of the hole of the aperture may be non-zero in the projection rule in the two-dimensional image estimation processing executed by the learning device 1, and the size of the hole of the aperture may be non-zero also in the projection rule in the two-dimensional image estimation process executed by the estimation device 2. That is, it is sufficient that the size of the hole of the aperture in the two-dimensional image estimation processing executed by at least one of the learning device 1 and the estimation device 2 is non-zero.

This is because, in any case, estimation including non-zero information on the size of the hole of the aperture is performed in the estimation by the estimation device 2. As a result, the estimation device 2 can estimate a blurred image that is an image expected by the user of the estimation device 2. Therefore, the estimation device 2 configured as described above can suppress deterioration in accuracy of estimating the imaging result by the imaging device.

### <Case of “At the Time of Learning: Size of Aperture is Non-Zero”>

By setting the size of the hole of the aperture in the projection rule in the two-dimensional image estimation processing executed by the learning device 1 to be non-zero, it is possible to estimate a blurred image. As a result, even if a blurred image is included in the output-side data of the three-dimensional learning data, since an image close to the blurred image can be estimated, learning is easy (the estimation result and the learning data are easily brought close to each other), and as a result, the three-dimensional image estimation accuracy of the three-dimensional image estimation model can be improved. Then, as the accuracy of the three-dimensional image estimation model increases, the estimation accuracy of the two-dimensional image estimated based on the accuracy also increases.

### <Case of “At the Time of Estimation: Size of Aperture is Non-Zero”>

By setting the size of the hole of the aperture in the projection rule in the two-dimensional image estimation processing executed by the estimation device 2 to be non-zero, a blurred image can be estimated. As a result, in a case where an imaging result by the camera with an aperture is to be reproduced, specifically, in a case where a depth of field effect caused by an operation of an in-focus position or a change in the size of the aperture is to be reproduced, the device can express a blur effect, so that the estimation accuracy of the two-dimensional image can be improved.

As described above, when the information indicating that the size of the hole of the aperture is not non-zero is used in the estimation by the estimation device 2, it is possible to suppress deterioration in accuracy of estimating the result of imaging by the imaging device. The estimation by the estimation device 2 is specifically executed by the estimation unit 211. Therefore, estimation by the estimation device 2 described in the modification is also executed in step S202. In this case, the processing in step S202 is processing in which the estimation unit 211 estimates the result of imaging by the imaging device in which the aperture is located at the position indicated by the input information using the mathematical model satisfying the model condition instead of the learned three-dimensional image estimation model.

The user using such an estimation device 2 can obtain a two-dimensional image in which the degree of blurring is changed by changing the size indicated by the hole size information. In addition, the user using such an estimation device 2 can obtain a two-dimensional image in which the in-focus position is changed by changing the focal length indicated by the focal length information. Furthermore, using such an estimation device 2, the user can also acquire a depth image.

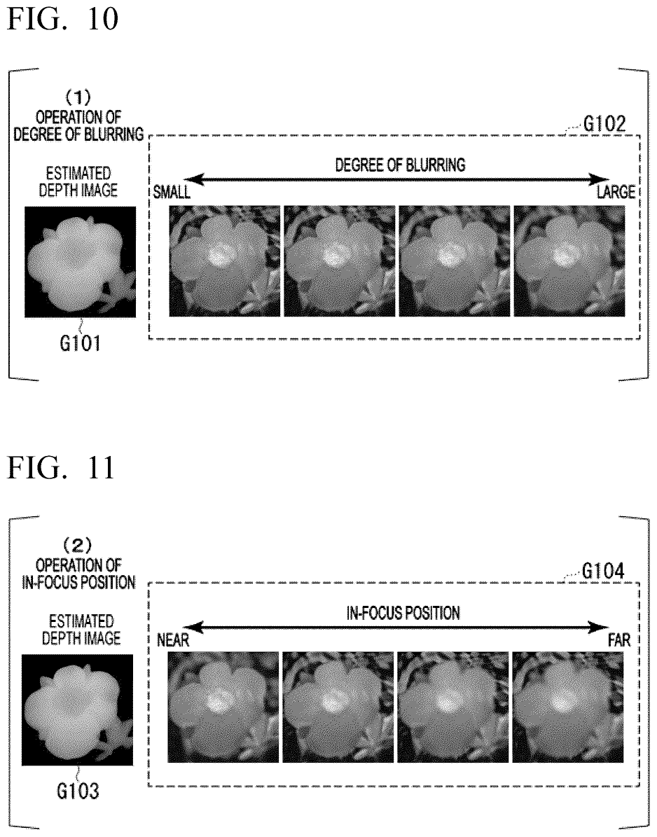

FIG. 10 is a first diagram illustrating an example of a result of estimation by the estimation device 2 according to a modification. An image G101 in FIG. 10 indicates the estimated depth image. An image G102 in FIG. 10 illustrates the estimated images in the order of the degree of blurring. FIG. 10 indicates that the estimation device 2 can estimate a blurred image. Specifically, it is indicated that the estimation device 2 can obtain a two-dimensional image in which the degree of blurring is changed by changing the size indicated by the hole size information.

FIG. 11 is a second diagram illustrating an example of a result of estimation by the estimation device 2 according to a modification. An image G103 in FIG. 11 indicates the estimated depth image. An image G104 of FIG. 11 illustrates the estimated images in order of the in-focus position. FIG. 11 indicates that the estimation device 2 can estimate a blurred image. Specifically, it indicates that the estimation device 2 can obtain a two-dimensional image in which the in-focus position is changed by changing the focal length indicated by the focal length information.

The input unit 22 and the communication unit 23 are an example of an input information acquisition unit. The three-dimensional image estimation model is an example of the estimation model.

Each of the learning device 1 and the estimation device 2 is not necessarily configured by one housing. Each of the learning device 1 and the estimation device 2 may be implemented by using a plurality of information processing devices communicably connected to each other via a network. In this case, the functional units included in each of the learning device 1 and the estimation device 2 may be implemented in a distributed manner in the plurality of information processing devices.

Note that the learning device 1 and the estimation device 2 do not necessarily need to be mounted as different devices. The learning device 1 and the estimation device 2 may be implemented as one device.

All or some of the functions of the learning device 1 and the estimation device 2 may be implemented by using hardware such as an application specific integrated circuit (ASIC), a programmable logic device (PLD), or a field programmable gate array (FPGA). The program may be recorded on a computer-readable recording medium. The computer-readable recording medium is, for example, a portable medium such as a flexible disk, a magneto-optical disc, a ROM, or a CD-ROM or a storage device such as a hard disk built in a computer system. The program may be transmitted via an electrical communication line.

Although the embodiments of this invention have been described in detail with reference to the drawings, specific configurations are not limited to this embodiment and include design and the like within the scope without departing from the concept of this invention.

### REFERENCE SIGNS LIST

100 Estimation system
1 Learning device
2 Estimation device
11 Control unit
12 Input unit
13 Communication unit
14 Storage unit
15 Output unit
111 Learning unit
112 Input control unit
113 Communication control unit
114 Storage control unit
115 Output control unit
21 Control unit
22 Input unit
23 Communication unit
24 Storage unit
25 Output unit
211 Estimation unit
212 Input control unit
213 Communication control unit
214 Storage control unit
215 Output control unit
91 Processor
92 Memory
93 Processor
94 Memory

1. An estimation apparatus comprising:
a first processor;
a first storage medium having computer program instructions stored thereon, wherein the computer program instruction, when executed by the first processor, perform processing of:
estimating a result of imaging by an imaging device by using an estimation model that estimates three-dimensional data of a target to be imaged by the imaging device based on hole position information indicating a position of a hole of an aperture of the imaging device including the aperture,
wherein information indicating that a size of the hole is not non-zero is used in the estimation.

2. The estimation apparatus according to claim 1,
wherein the estimation model is obtained by learning,
in the learning, one or a plurality of pieces of learning data including input-side data that is data input to a mathematical model of a target to be learned and output-side data that is data used for comparison with an output of the mathematical model of the target to be learned are used,
the input-side data includes the hole position information,
the output-side data includes a two-dimensional image capturing the target to be imaged, and
the mathematical model of the target to be learned in the learning is updated so as to reduce a difference between a set of results of estimation by the mathematical model of the target to be learned and a set of the output-side data.

3. The estimation apparatus according to claim 2,
wherein, in the learning,
the estimater estimating the result of imaging by the imaging device by using the estimation model is used as a generator,
a discriminator that discriminates a set of results of estimation by the generator and a set of output-side data is included, and
the generator and the discriminator learn the target to be learned according to optimization conditions that conflict with each other.

4. The estimation apparatus according to claim 1,
wherein a latent variable that is a quantity for identifying the target is used for estimating the result of imaging by the imaging device.

5. The estimation apparatus according to claim 1,
wherein information indicating orientation of the hole of the aperture is used for estimating the result of imaging by the imaging device.

6. The estimation apparatus according to claim 1,
wherein the estimation model includes a neural network.

7. A learning apparatus comprising:
a first processor;
a first storage medium having computer program instructions stored thereon, wherein the computer program instruction, when executed by the first processor, perform processing of:
learning an estimation model that estimates a three-dimensional data of a target to be imaged by an imaging device based on hole position information indicating a position of a hole of an aperture of the imaging device including the aperture,
wherein, in the learning, one or a plurality of pieces of learning data including input-side data that is data input to a mathematical model of a target to be learned and output-side data that is data used for comparison with an output of the mathematical model of the target to be learned are used,
the input-side data includes the hole position information,
the output-side data includes a two-dimensional image capturing the target to be imaged, and
the mathematical model of the target to be learned in the learning is updated so as to reduce a difference between a set of results of estimation by the mathematical model of the target to be learned and a set of the output-side data.

8. The learning apparatus according to claim 7,
wherein, in the learning,
a generator that estimates a result of imaging by the imaging device using the estimation model, and
an discriminator that discriminates the set of results of estimation and the set of the output-side data are included, and
the generator and the discriminator learn the target to be learned according to optimization conditions that conflict with each other.

9. An estimation method comprising:
estimating a result of imaging by an imaging device by using an estimation model that estimates three-dimensional data of a target to be imaged by the imaging device based on hole position information indicating a position of a hole of an aperture of the imaging device including the aperture,
wherein information indicating that a size of the hole is not non-zero is used in the estimation.

10. (canceled)

11. (canceled)
